(19) United States
(12) Patent Application Publication
(10) Pub. No.: US 2012/0213515 A1
(43) Pub. Date: Aug. 23, 2012

(54) SERVICE GROUP AGGREGATION

(76) Inventors: Zoran Maricevic, West Hartford, CT (US); Marcel F. Schemmann, Maria Hoop (NL); Zhijian Sun, Avon, CT (US); Dean Painchaud, Cromwell, CT (US); Jeffrey L. Sauter, State College, PA (US); William P. Dawson, Manlius, NY (US)

(21) Appl. No.: 13/030,573

(22) Filed: Feb. 18, 2011

(51) Int. Cl. H04J 14/00

(52) U.S. Cl. 398/45

(57) ABSTRACT

Methods and systems for aggregating service groups are provided. A chain of fiber nodes in a DOCSIS system is formed to aggregate the service groups served by the fiber nodes to form a super-service group. Multiple channels of a multiplexed data stream are used to transmit the signals from the super-service group. By creating a chain of fiber nodes and using multiple channels to transmit the signals from the super-service group, a DOCSIS system can be more efficiently reconfigured to segment a super-service group once the system has become exhausted.

### TECHNICAL FIELD

This disclosure relates to service group aggregation.

### BACKGROUND

A Data-Over-Cable Service Interface Specification (DOCSIS) system can be used to deliver high-definition digital entertainment and telecommunications such as video, voice, and high-speed Internet to subscribers over an existing cable television network. The cable television network can take the form of an all-coax, all-fiber, or hybrid fiber/coax (HFC) network. A multiple service operator (MSO) can deliver these services to subscribers by using cable modem termination systems (CMTSs) located at a headend or hub and customer premise equipment (CPE) devices located at subscriber premises. A CMTS routes traffic (e.g., data, video, and voice signals) to and from CPE devices on downstream and upstream channels, respectively. The CPE device can include cable modems (CMs), which can include embedded multimedia terminal adapters (eMTAs).

This disclosure generally describes DOCSIS-based network architectures that may conserve network components (e.g., including fiber, optical bandwidth, and headend components, among others) and/or can be more efficiently reconfigured to meet the changing demands of a network.

### BRIEF DESCRIPTION OF THE DRAWINGS

FIG. 1 is a block diagram illustrating an example DOCSIS-based system operable to provide communication between a headend/hub and CMs.

FIG. 2 is a block diagram illustrating an example DOCSIS-based system in more detail.

FIG. 3 is a block diagram illustrating another example DOCSIS-based system.

FIG. 4 is a block diagram illustrating an example DOCSIS-based system that employs service group aggregation.

FIG. 5 is a block diagram illustrating an example DOCSIS-based system employing node segmentation/splitting.

FIGS. 6A and 6B are block diagrams illustrating example systems employing service group aggregation to form an initial super-service group, including the capability to more efficiently segment the super-service group upon instruction.

FIG. 7A is a block diagram illustrating implementations of a first fiber node in a fiber node chain.

FIG. 7B is a block diagram illustrating implementations of remaining fiber nodes in a fiber node chain.

FIG. 8 is a block diagram illustrating another example system used to initially employ service group aggregation to form a super-service group and includes the capability to more efficiently segment the super-service group upon instruction.

FIG. 9 is a block diagram illustrating implementations of a master node.

FIG. 10 is a block diagram illustrating an example system reconfigured to segment a super-service group.

FIG. 11 is a flowchart illustrating an example process operable to aggregate service groups served by fiber nodes, respectively, to form a super-service group that may be more efficiently segmented in the future.

### DETAILED DESCRIPTION

Various implementations of this disclosure form a chain of fiber nodes in a system (e.g., a DOCSIS-based system) to aggregate the service groups served by the fiber nodes to form a super-service group. Various implementations of this disclosure can also use multiple channels of a multiplexed data stream to transmit the signals from the super-service group. By forming a chain of fiber nodes and using multiple channels to transmit the signals from the super-service group, a DOCSIS system can be more efficiently reconfigured to segment a super-service group when the need arises. Thus, the fiber nodes of a super-service group can be separated into smaller segments.

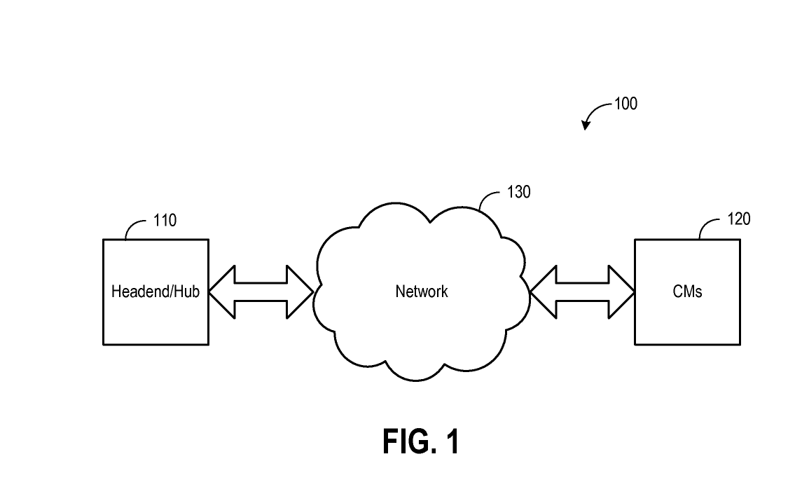

As shown in FIG. 1, communications (e.g., data, video, and voice signal) are transmitted over a cable network 130 via one or more channels between a headend/hub 110 and cable modems CMs 120, which can be located at subscriber premises. The cable network 130 can take the form of an all-coax, all-fiber, or hybrid fiber/coax (HFC) network. Communications transmitted from the headend/hub 110 to a CM 120 is said to travel in a downstream direction on one or more downstream channels; conversely, communications transmitted from a CM 120 to the headend/hub 110 is said to travel in an upstream direction on one or more upstream channels.

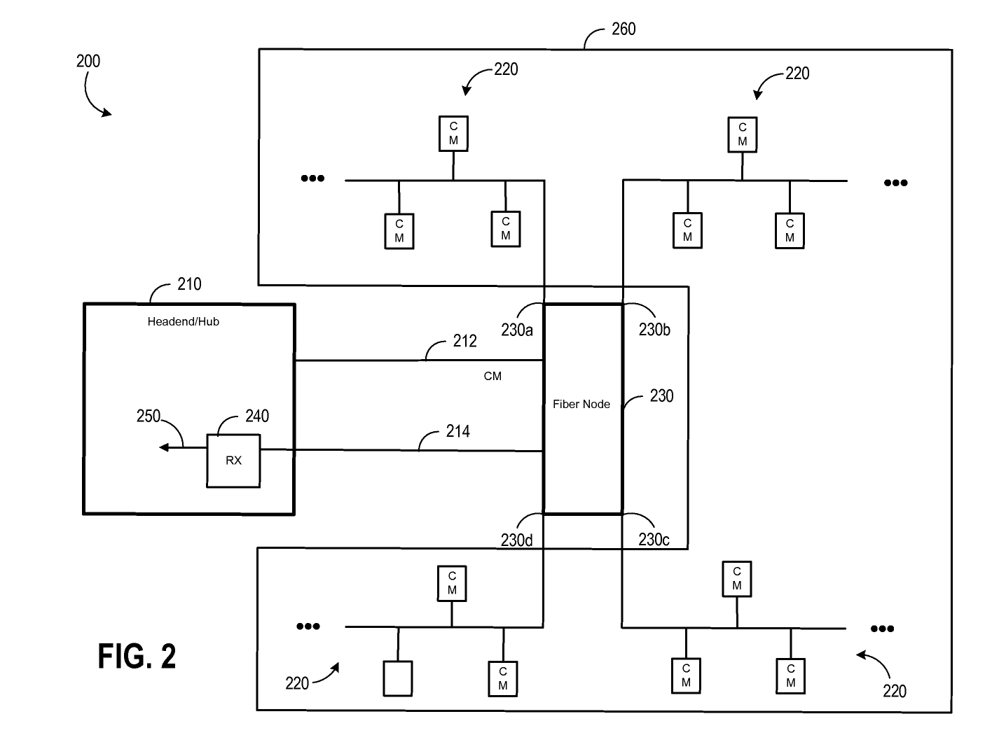

FIG. 2 illustrates an example DOCSIS system of FIG. 1 in more detail. The DOCSIS system 200 of FIG. 2 uses two fibers 212, 214 for bi-directional communication between a headend/hub 210 and CMs 220. The headend/hub 210 transmits optical signals downstream to a fiber node 230 via a fiber 212. The fiber node 230 includes an optical receiver that converts the received optical signals to electrical signals that are transmitted to the CMs 220 that are served by the fiber node 230 (i.e., service group 260).

The fiber node 230 also includes an upstream optical transmitter that combines the electrical signals received from the CMs 220 in service group 260 and converts the resulting electrical signals to optical signals and transmits the optical signals upstream to the headend/hub 210 via the fiber 214.

In the headend/hub 210, a receiver 240 can operate to convert the upstream optical signals to electrical signals, which represents the electrically combined signals from the four ports 230a-d of the fiber node 230. The receiver 240 can then output these electrical signals 250 to one of its RF output ports.

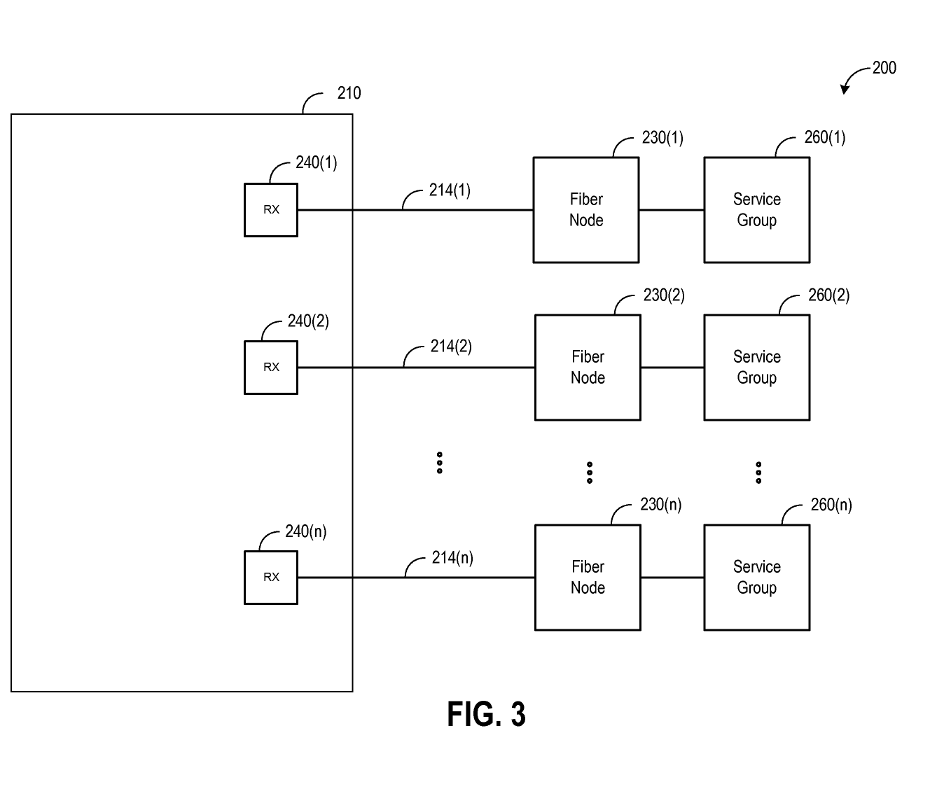

FIG. 3 is similar to FIG. 2 and illustrates an example DOCSIS system with multiple fiber nodes 230(1), . . . , 230(n) and corresponding service groups 260(1), . . . , 260(n), respectively. As shown in FIG. 3, each fiber node 230(1), . . . , 230(n) has its own dedicated receiver 240(1), 240(2), . . . , 240(n) in the headend/hub 210. However, it can be inefficient to dedicate a single receiver to a single fiber node if a receiver is capable of handling additional capacity from additional fiber nodes.

Service group aggregation is a technique that can be used to expand the number of fiber nodes and thus CMs dedicated to a single receiver thereby, among other things, reducing the number of receivers needed in the headend/hub 210.

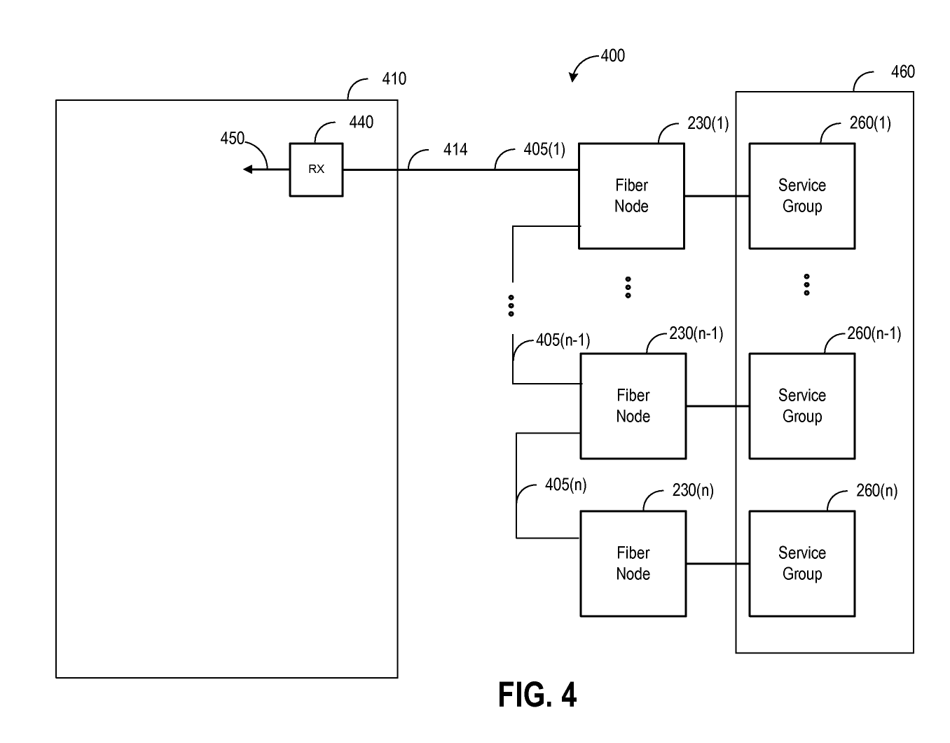

Referring to FIG. 3, with service group aggregation, the CMs that are served by fiber nodes 230(1), . . . , 230(n) (e.g., service groups 260(1), . . . , 260(n), respectively) can be aggregated into one super-service group. For example, as illustrated in FIG. 4, the service groups 260(1), . . . , 260(n) can be aggregated into one super-service group 460. Additionally, as shown in FIG. 4, in one implementation, with service group aggregation, a chain of fiber nodes can be formed by connecting the output of one fiber node to the input of the next fiber node in the chain. The output of each fiber node is on the same channel and the output from the last fiber node in the chain (i.e., the master node) can be transmitted on one channel upstream via fiber 414 to a single receiver 440.

More specifically, the optical signals 405(n) from the first fiber node 230(n) in the chain, which represent the combined signals from the CMs in service group 260(n) served by fiber node 230(n), are received by the next fiber node in the chain, i.e., fiber node 230(n−1). Fiber node 230(n−1) can extract the digital signals from the optical signals 405 received from fiber node 230(n) and combine them with the digital signals representing the combined signals from the CMs in service group 260(n−1). Fiber node 230(n−1) can then convert the resulting digital signals, which represent the combined signals from the CMs in service groups 260(n) and 260(n−1), to optical signals 405(n−1) and can transmit the optical signals to the next fiber node in the chain, i.e., fiber node 230(n−2). This process can be repeated up to the last fiber node 230(1) in the chain. The optical signals 405(1) output from fiber node 230(1), which represent the combined signals from the CMs in service groups 260(1), . . . , 260(n), are transmitted upstream via fiber 414 to a single receiver 440. In this way, the number of fiber nodes dedicated to a single receiver is increased thereby reducing the number of receivers needed in the headend/hub 210. From the headend/hub 210 perspective, there exists one super-service group 460 that includes all the CMs that are served by fiber nodes 230(1), . . . , 230(n). The receiver 440 can convert the upstream optical signals 405(1) to electrical signals 450 and output these signals to one of its RF output ports.

The capacity of a fiber link (for example, fiber link 414) in a network can become exhausted. There can be numerous reasons for the reduced capacity. For example, there can be an increase in the data rates of the CMs served by a fiber node(s) (e.g., CMs that are served by fiber nodes 230(1), . . . , 230(n)) that utilize the fiber link thereby reducing an upstream fiber link. As another example, there can be an increase in the delivery of expanded services, which results in more traffic to be transmitted over a fiber link. Node segmentation/splitting is a technique that can be used to expand the capacity of a network without using additional fiber.

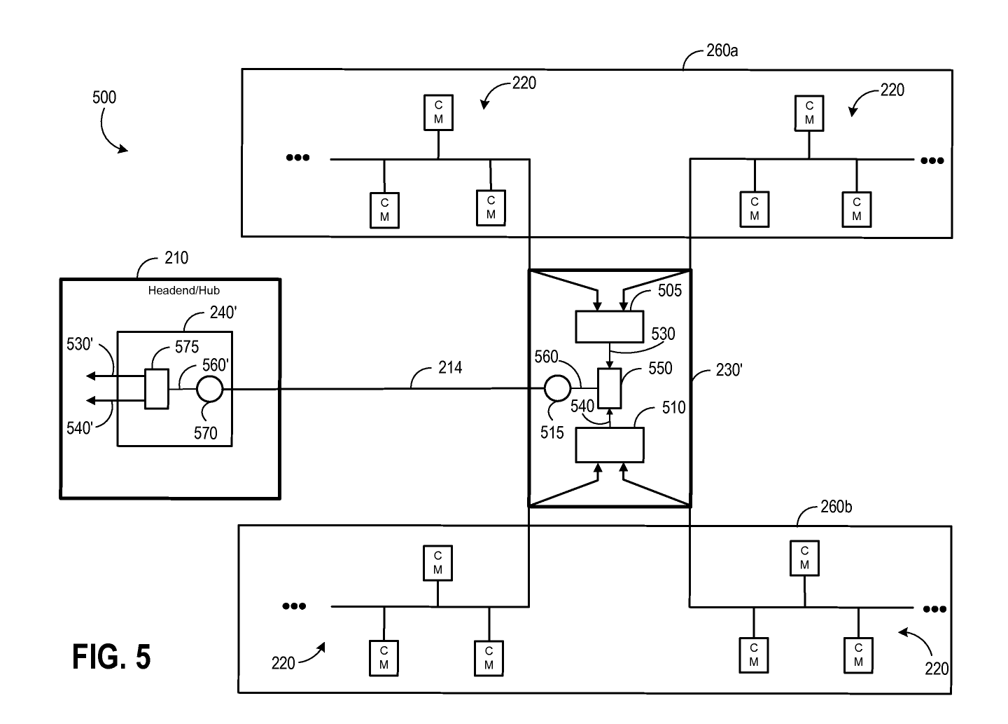

Referring to FIG. 2, with node segmentation/splitting, the group of modems 220 served by fiber node 230 (i.e., service group 260) can be segmented or split into two or more sub-service groups. For example, as illustrated in FIG. 5, the service group 260 can be segmented into two sub-service groups 260a, 260b. Additionally, the fiber node 230 of FIG. 2 can be segmented. That is, for example, as shown in FIG. 5, in the fiber node 230′, a combiner 505 can combine the electrical signals received from all the CMs in the sub-service group 260a and produce a resulting electrical signal 530. The combiner 510 also can combine the electrical signals received from all the CMs in the sub-service group 260b and produce a resulting electrical signal 540. The resulting electrical signals 530, 540 can be further processed (e.g., amplified, filtered, and digitized) and then multiplexed by a multiplexer 550 to produce a single multiplexed data stream 560. In some implementations, multiplexer 550 can be a time division multiplexer (TDM). The multiplexed data stream 560 can be converted to an optical signal by optical transmitter 515 and transmitted upstream to headend/hub 510 via fiber 514. The downstream fiber 512 and corresponding circuitry in the headend/hub 510 and fiber node 530′ are not shown for clarity.

At the headend/hub 510, in a receiver 540′, a converter 570 can convert the optical signals to electrical signals 560′, which represent the multiplexed data stream 560. The resulting multiplexed data stream 560′ can be de-multiplexed by demultiplexer 575 into two electrical signals 530′ and 540′ representing electrical signal 530 and 540, respectively. The resulting electrical signals 530′ and 540′ can be further processed (e.g., by a digital-to-analog converter and amplifier) and then output to two separate RF output ports.

Thus, using node segmentation/splitting, the N cable modems in one service group (for example, service group 260 of FIG. 2) no longer have to all contend for the same upstream bandwidth. Instead, the service group can be segmented into multiple smaller service groups (for example, service group 260a, 260b of FIG. 5) and bandwidth can be dedicated to each service group (for example, via TDM). As a result, the bandwidth that is allocated to a service group is shared by fewer CMs, thereby increasing the bandwidth per CM. Furthermore, each sub-service group has its own output at the receiver in the headend/hub.

In a system including a super-service group as a result of service group aggregation, when the capacity of the upstream fiber link (e.g., fiber link 414 of FIG. 4) used by the super-service group becomes exhausted, it can be desirable to segment/split the super-service group. However, the system 400 in the example of FIG. 4 is not configured to be easily upgraded or modified to segment the super-service group 460. More specifically, segmenting the super-service group 460 would include rewiring nodes, additional return fibers, and/or installation of additional digital return receivers.

In view of the foregoing, it would be constructive to aggregate service groups in a DOCSIS system to form a super-service group, among other things, to use the capacity of receivers in the headend/hub more fully, while also planning for more efficiently reconfiguring the system to segment the super-service group once the system has become exhausted. Accordingly, it can be helpful to develop more efficient systems and methods to aggregate service groups to form a super-service group and to later segment/split the super-service group when the need arises.

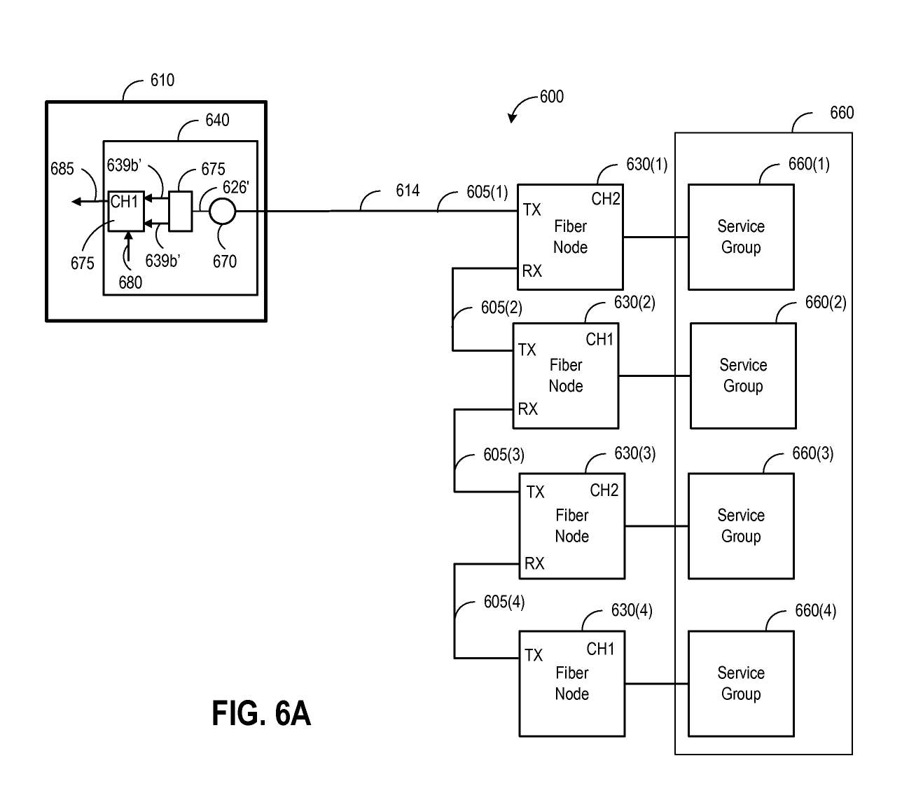

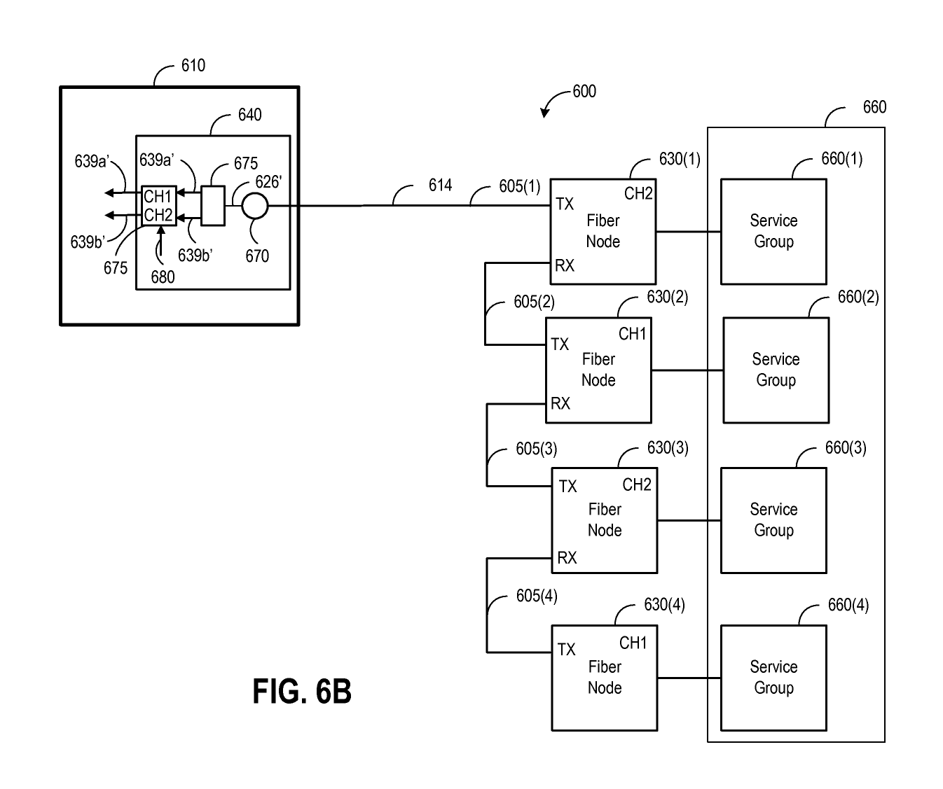

FIGS. 6A and 6B illustrate an example system 600 according to an example implementation that initially employs service group aggregation to form a super-service group and includes the capability to more efficiently segment the super-service group when the need arises. The example system 600 of FIGS. 6A and 6B includes four fiber nodes, however, this disclosure is not limited to four fiber nodes. This disclosure is intended to be applicable to more or less fiber nodes.

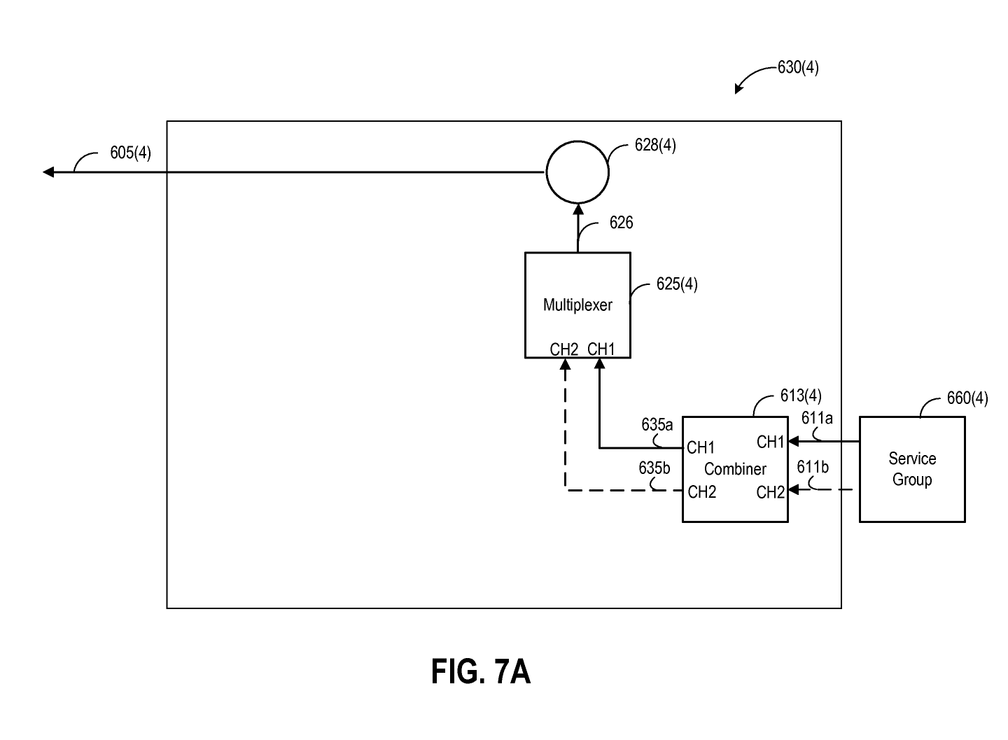

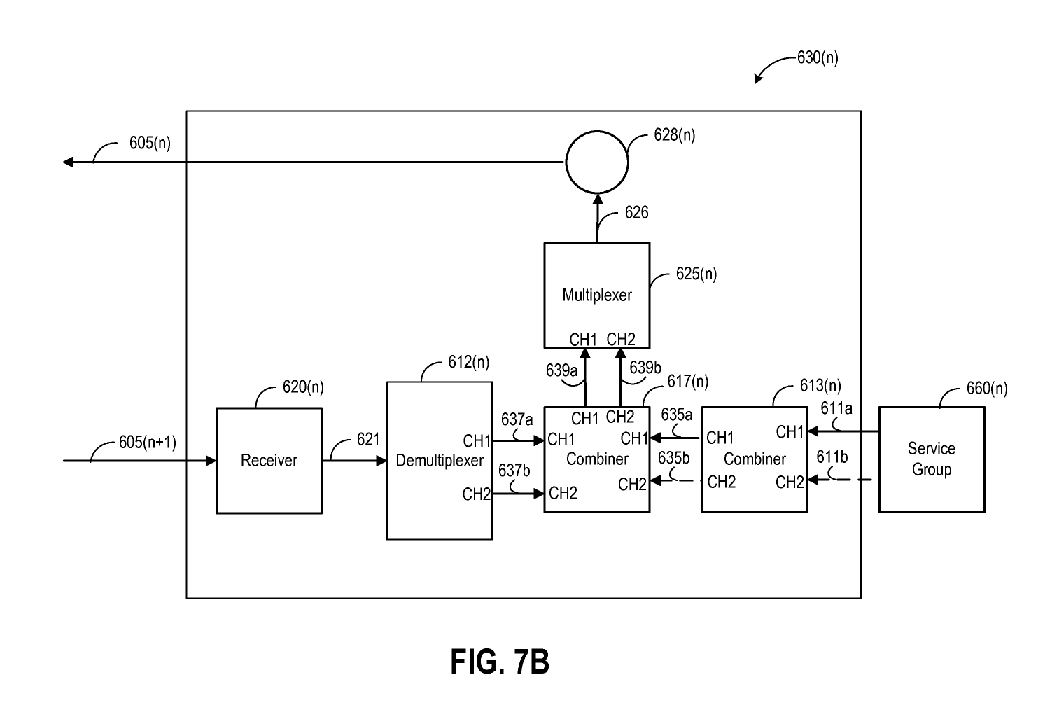

FIG. 7A illustrates one implementation of fiber node 630(4) of FIG. 6, the first fiber node of the chain. FIG. 7B illustrates one implementation of the remaining fiber nodes, 630(1), 630(2), 630(3) in the chain. The fiber node 630(4) can have less circuitry than fiber nodes 630(1), 630(2), 630(3) in the chain because it is the first fiber node in the chain.

Referring to FIG. 7A, the combiner 613(4) of fiber node 630(4) combines the electrical signals received from all the CMs in a service group 660(4) and produces a resulting electrical signal. The combiner 613(4) can receive a signal 611a or 611b on one of its input ports for a particular channel and output the resulting signal 635a or 635b, respectively, on one of its output ports for the channel. In the example implementation of FIG. 7A, the electrical signals received from all the CMs in service group 660(4) are input to a CH1 input port of combiner 613(4) and the resulting signal 635a is output on a corresponding CH1 output port. The dotted lines in the example of FIG. 7A illustrate that, in some implementations, a CH2 input 611b can be received at the combiner 613(4) and transmitted as an output a signal at the CH2 output port.

In some implementations, the resulting electrical signal 635a or 635b can be further processed (e.g., amplified, filtered, and/or digitized). In FIG. 7A, the resulting electrical signal 635a or 635b from combiner 613(4) is multiplexed by a multiplexer 625(4) to produce a single multiplexed data stream 626 where the signal 635a or 635b is included in the designated channel of the resulting multiplexed data stream 626. For example, in FIG. 7A, the electrical signals from all the CMs in service group 660(4) (e.g., resulting electrical signals 635a) can be allocated to a first TDM channel representing CH1. In some implementations, a multiplexer 625(4) can use a time division multiplexing (TDM). An optical transmitter 628(4) can converts the multiplexed digital signals 626 to optical signals 605(4) to be transmitted to the next fiber node 630(3) in the chain.

Referring to FIG. 7B, in each of fiber nodes 630(n) for n=N−1, N−2, . . . , 1, the combiner 613(n) combines the electrical signals received from all the CMs in a service group 660(n) and produces a resulting electrical signal. The combiner 613(n) of FIG. 7B can operate the same as the combiner 613(4) of FIG. 7B.

A receiver 620(n) can extract the digital signals from the optical signals 605(n+1) received from the previous fiber node 630(n+1). Demultiplexer 612(n) is operable to de-multiplex the digital signals 621 received from receiver 620(n) and can transmit the separate signals 637a, 637b on separate output ports corresponding to the different channels on which the demultiplexed signals 637a, 637b are to be transmitted.

The combiner 617(n) can receive as its input the output signals 637a, 637b from the demultiplexer 612(n) and the resulting electrical signals 635a or 635b from combiner 613(n). The inputs can be received on separate input ports based on the channel for which the input signals are to be transmitted. Thus, in the example of FIG. 7B, the CH1 and CH2 outputs of demultiplexer 612 and the CH1 and CH2 output 635a or 635b from combiner 613 are received at the CH1 and CH2 inputs, respectively, of combiner 617(n).

The combiner 617(n) can include a separate output port for each channel for which a signal can be transmitted. The combiner 617(n) is operable to combine the signals received from different inputs for the same channel and can transmit the resulting signals 639a or 639b on an output port for the channel. Thus, combiner 617(n) combines the resulting signal 635a (if any), which is received on a CH1 input, with signal 637a (if any), which also is received on a CH1 input, and transmits a combined signal 639a on a CH1 output port. Similarly, combiner 617(n) combines the resulting signal 635b (if any), which is received on a CH2 input, with signal 637b (if any), which also is received on a CH2 input, and transmits a combined signal 639b on a CH2 output port.

In the example of FIG. 7B, combiner 617(n) combines the resulting signal 635a, which is received on a CH1 input, with signal 637a (if any), which also is received on a CH1 input, and transmits the resulting signal 639a on a CH1 output port. The combiner 617(n) transmits the output signals 637b, which are received on a CH2 input, on a CH2 output port.

The output signals 639a, 639b from combiner 617(n) are multiplexed by a multiplexer 625(n) to produce a single multiplexed data stream 626. In some implementations, the multiplexer 625(n) can be a time division multiplexer (TDM).

Optical transmitter 628(n) then converts the multiplexed digital signals 626 to optical signals 605(n) to be transmitted to the next fiber node 630(n−1) in the chain or the headend/hub if fiber node 630(n) is the last fiber node in the chain (i.e., fiber node 630(1)).

Referring back to FIGS. 6A and 7A, in a fiber node 630(4), a combiner 613(4) can receive the electrical signals from all the CMs in service group 660(4) on its CH1 input port and can combine the received electrical signals to produce a resulting electrical signal 635a that is output on its CH1 output port. The resulting electrical signals 635a can be multiplexed by a multiplexer 625(4) to produce a single multiplexed data stream 626. For example, the electrical signals from all the CMs in service group 660(4) (e.g., signals 635a) can be allocated to a first TDM channel representing CH1. The optical transmitter 628(4) then converts the multiplexed digital signals 626 to optical signals 605(4) to be transmitted to fiber node 630(3).

Referring to FIGS. 6A and 7B, in fiber node 630(3), combiner 613(3) can receive the electrical signals from all the CMs in service group 660(3) at its CH2 input port and can combine these electrical signals to produce a resulting electrical signal 635b that is output on its CH2 output port.

The receiver 620(3) can extract the digital signals from the optical signals 605(4) received from fiber node 630(4). Since the optical signals 605(4) received from fiber node 630(4) represent signals transmitted on CH1, demultiplexer 612(3) de-multiplexes the digital signals to produce output signals 637a, which are output on its CH1 output port. The output signals 637a represent the electrical signal from all the CMs in service group 660(4).

The combiner 617(3) can transmit signals 637a, which represents the electrical signals from all the CMs in service group 660(4), on its CH1 output port as output signal 639a. The combiner 617(3) can also transmit signal 635b, which represents the electrical signals from all the CMs in service group 660(3), on its CH2 output port as output signal 639b.

The output signals 639a (representing the electrical signal from all the CMs in service group 660(4)) and 639b (representing the electrical signals from all the CMs in service group 660(3)) from combiner 617(3) are multiplexed by a multiplexer 625(3) to produce a single multiplexed data stream 626. For example, the electrical signals from all the CMs in service group 660(4) (e.g., output signal 639a(3)) can be allocated to a first TDM channel representing CH1, and the electrical signals from all the CMs in service group 660(3) (e.g., output signal 639b(3)) can be allocated to a second TDM channel representing CH 2.

The optical transmitter 628(3) can then convert the multiplexed digital signals 626 to optical signals 605(3) to be transmitted to fiber node 630(2).

In fiber node 630(2), combiner 613(2) receives the electrical signals from all the CMs in service group 660(2) at its CH1 input port and combines these electrical signals to produce a resulting electrical signal 635a that is output on its CH1 output port.

The receiver 620(2) can extract the digital signals from the optical signals 605(3) received from fiber node 630(3). Since the optical signals 605(3) received from fiber node 630(3) represent signals transmitted on CH1 and CH2, demultiplexer 612(2) de-multiplexes the digital signal to produce output signals 637a (representing the electrical signals from all the CMs in service group 660(4)), which are transmitted on its CH1 output port and output signals 637b (representing the electrical signals from all the CMs in service group 660(3)), which are transmitted on its CH2 output port.

The combiner 617(2) can combine signal 635a, which represents the electrical signals from all the CMs in service group 660(2), with signal 637a, which represents the electrical signals from all the CMs in service group 660(4), and transmit the combined signal 639a on CH1 output port. Combiner 617(2) can transmit signal 637b, which represents the electrical signals from all the CMs in service group 660(3), on its CH2 output port as output signal 639b.

The output signals 639a (representing the electrical signal from all the CMs in service group 660(2) and service group 660(4)) and 639b (representing the electrical signals from all the CMs in service group 660(3)) from combiner 617(2) are multiplexed by a multiplexer 625(2) to produce a single multiplexed data stream 626. For example, the electrical signals from all the CMs in service groups 660(2) and 660(4) (i.e., output signal 639a) can be allocated to a first TDM channel representing CH1, and the electrical signals from all the CMs in service group 660(3) (i.e., output signal 639b) can be allocated to a second TDM channel representing CH2.

The optical transmitter 628(2) can then convert the multiplexed digital signals 626 to optical signals 605(2) to be transmitted to fiber node 630(1).

In fiber node 630(1), combiner 613(1) can receive electrical signals from all the CMs in service group 660(1) at its CH2 input port the and can combine these electrical signals to produce a resulting electrical signal 635b that is output on its CH2 output port.

The receiver 620(1) extracts the digital signals from the optical signals 605(2) received from fiber node 630(2). Since the optical signals 605(2) received from fiber node 630(2) represent signals transmitted on CH1 and CH2, demultiplexer 612(1) can de-multiplex the digital signal to produce output signals 637a (representing the electrical signals from all the CMs in service groups 660(2) and 660(4)), which are transmitted on its CH1 output port and output signal 637b (representing the electrical signals from all the CMs in service group 660(3)), which are transmitted on its CH2 output port.

Combiner 617(1) can transmit signal 637a, which represents the electrical signals from all the CMs in service groups 660(2) and 660(4), on its CH1 output port as output signal 639a. Combiner 617(1) can combine signal 635b, which represents the electrical signals from all the CMs in service group 660(1), with signal 637b, which represents the electrical signals from all the CMs in service group 660(3), and output the combined signal 639b on its CH2 output port.

The output signals 639a (representing the electrical signals from all the CMs in service groups 660(2) and 660(4)) and 639b (representing the electrical signals from all the CMs in service groups 660(1) and 660(3)) from combiner 617(1) can be multiplexed by a multiplexer 625 to produce a single multiplexed data stream 626. For example, the electrical signals from all the CMs in service groups 660(2) and 660(4)(i.e., output signal 639a(1)) can be allocated to a first TDM channel representing CH1, and the electrical signals from all the CMs in service groups 660(1) and 660(3) (i.e., output signal 639b(3)) can be allocated to a second TDM channel representing CH2.

The optical transmitter 628(1) can then convert the multiplexed digital signals 626 to optical signals 605(1) to be transmitted upstream via fiber 614 to a single receiver 640 at the headend/hub 610.

Referring to FIG. 6A, in the receiver 640, a converter 670 can convert the optical signals 605(1) to electrical signals 626′ that represent the multiplexed data stream 626 from fiber node 630(1). The resulting multiplexed data stream 626′ can be de-multiplexed by demultiplexer 675 into two electrical signals 639a′ and 639b′ representing electrical signal 639a and 639b from fiber node 630(1), respectively. The receiver 640 can include a processor 675 that receives the two electrical signals 639a′ and 639b′ from the demultiplexer 675. Based on a control signal 680, the processor 675 can digitally sum the two electrical signals 639a′ and 639b′ and transmit the resulting signal 685 (representing the electrical signals from all the CMs in service groups 660(1), 660(2), 660(3), and 660(4)) on one RF output port as shown in FIG. 6A, or alternatively, the processor 475 can transmit the two electrical signals 639a′ (representing the electrical signals from all the CMs in service groups 660(2) and 660(4)) and 639b′ (representing the electrical signals from all the CMs in service groups 660(1) and 660(3)) to two separate RF output ports, respectively, as shown in FIG. 6B. Some implementations of receiver 640 are described in U.S. patent application Ser. No. 12/906,612, entitled “Node Segmentation,” which was filed on Oct. 18, 2010, and is incorporated herein by reference in its entirety.

By forming a chain of fiber nodes to aggregate the service groups served by the fiber nodes to form a super-service group and using multiple channels to transmit the signals from the CMs in the super-service group, a DOCSIS system can be more efficiently reconfigured to segment a super-service group once the system has become exhausted by, for example, changing a control signal in the receiver.

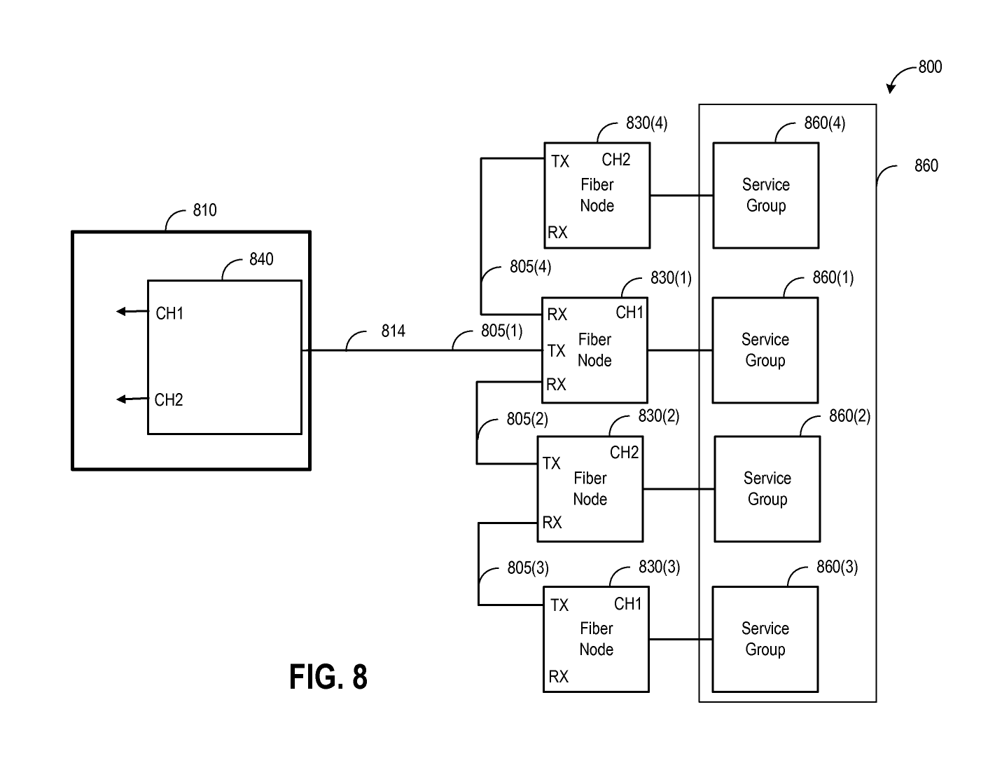

FIG. 8 illustrates another example system 800 that initially employs service group aggregation to form a super-service group and includes the capability to more efficiently segment the super-service group when the need arises. In the example system 800, an implementation of fiber node 830(3) is shown in FIG. 7A, and an implementation of fiber node 830(2) is shown in FIG. 7B. Thus, fiber nodes 830(3) and 830(2) operate in a similar fashion to fiber nodes 630(4) and 630(3), respectively, in FIG. 6A. The example system 800, however, provides an additional level of segmentation over the system 600 of FIGS. 6A and 6B through the use of an additional receiver in the master node 830(1) to receive optical signals from an addition chain.

Generally, in the example system 800 of FIG. 8, the electrical signals from the first chain that includes fiber nodes 830(3) and 830(2) and the second chain that includes fiber node 830(4) are combined in the master node (e.g., fiber node 830(1)) to aggregate the service groups (e.g., service groups 860(1)-(4)) for both chains to from a super-service group 860. In the example system 800 of FIG. 8, the super-service group 860 can be segmented into more sub-service groups than the super-service group 660 of FIGS. 6A and 6B.

More specifically, the fiber node 830(1) can receive an optical signal 805(2) from fiber node 830(2) representing electrical signals from all the CMs in service group 860(3) transmitted on CH1 and electrical signals from all the CMs in service group 860(2) transmitted on CH2. The fiber node 830(1) can also receive an optical signal 805(4) from fiber node 830(4), the optical signal 805(4) representing electrical signals for all the CMs in service group 860(4) transmitted on CH2.

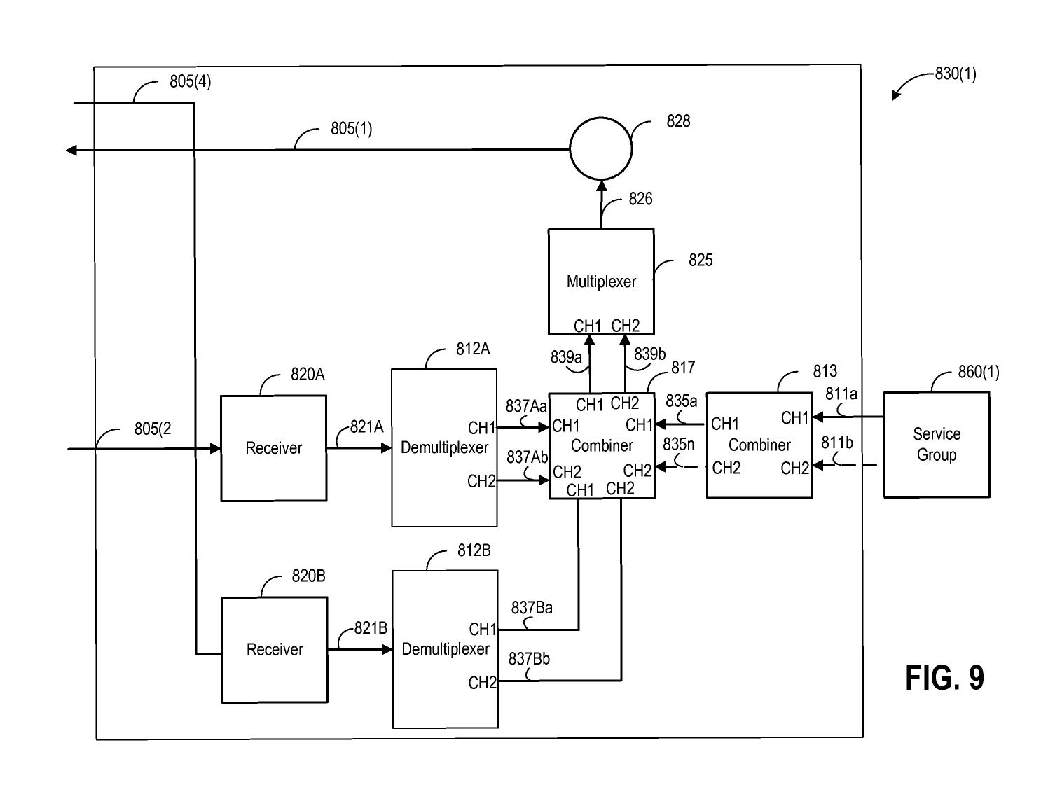

FIG. 9 illustrates an implementation of fiber node 830(1). At fiber node 830(1), combiner 813 can receive the electrical signals from all the CMs in service group 860(1) at a CH1 input port and can combine these electrical signals to produce a resulting electrical signal 835a that is output on a CH1 output port.

The receiver 820A can extract the digital signals from the optical signals 805(2) received from fiber node 830(2). Because the optical signals 805(2) received from fiber node 830(2) represent signals transmitted on CH1 and CH2, demultiplexer 812A de-multiplexes the digital signal to produce output signals 837Aa (representing the electrical signals from all the CMs in service group 860(3)), which are output on the its CH1 output port and output signals 837Ab (representing the electrical signals from all the CMs in service group 860(2)), which are output on its CH2 output port.

The receiver 820B can extract the digital signals from the optical signals 805(4) received from fiber node 830(4). Because the optical signals 805(4) received from fiber node 830(4) can represent multiple signals transmitted on CH2, demultiplexer 812 de-multiplexes the digital signals to produce output signals 837Bb, which are output on its CH2 output port. The output signals 837Bb represent the electrical signal from all the CMs in service group 860(4).

The combiner 817 can combine signal 835a, which represents the electrical signals from all the CMs in service group 860(1), with signal 837Aa, which represents the electrical signals from all the CMs in service group 860(3), and transmit the combined signal 839a on a CH1 output port. The combiner 817 can also combines signal 837Ab, which represents the electrical signals from all the CMs in service group 860(2), with signal 837Bb, which represents the electrical signals from all the CMs in service group 860(4), and transmit the combined signal 839b on a CH2 output port.

The output signals 839a (representing the electrical signal from all the CMs in service group 860(1) and service group 860(3)) and 839b (representing the electrical signals from all the CMs in service group 860(2) and service group 860(4)) from combiner 817 are multiplexed by a multiplexer 825 to produce a single multiplexed data stream 826. For example, the electrical signals from all the CMs in service groups 860(1) and 860(3) (e.g., output signal 839a) can be allocated to a first TDM channel representing CH1, and the electrical signals from all the CMs in service group 860(2) and 860(4) (e.g., output signal 839b) can be allocated to a second TDM channel representing CH2.

The optical transmitter 828 can then convert the multiplexed digital signals 826 to optical signals 805(1) to be transmitted upstream via fiber 814 to a single receiver 840 at the headend/hub 810.

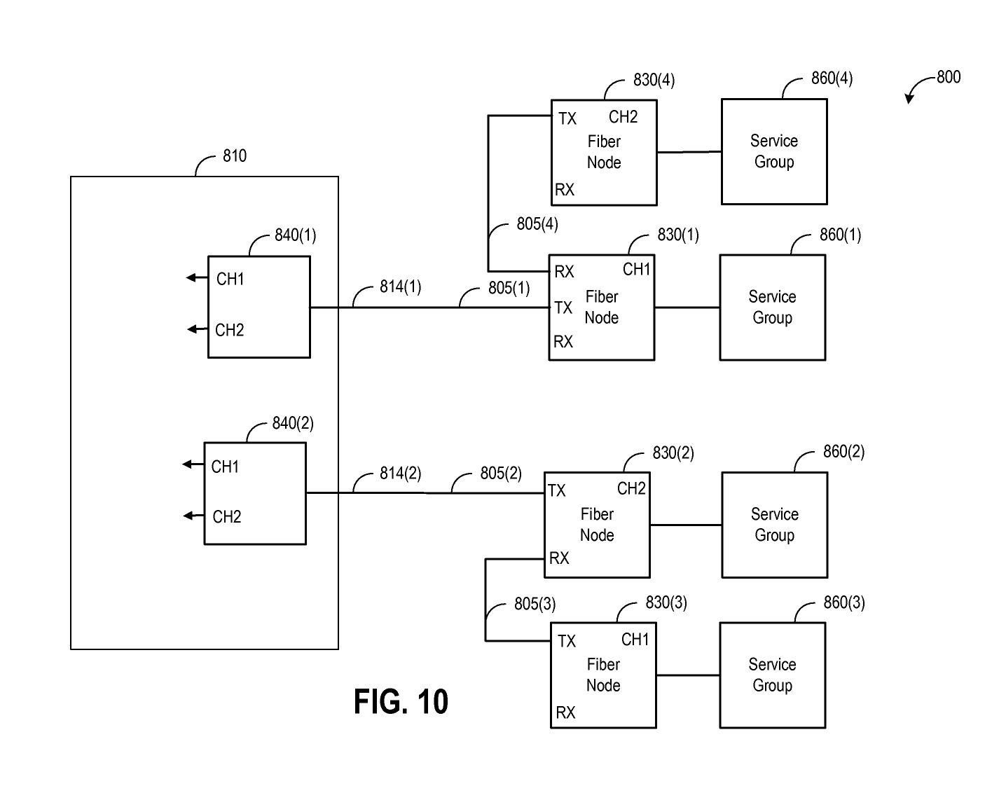

Referring to FIG. 8, the receiver 840 can operate similar to the receiver 640 of FIGS. 6A and 6B. When a network operator would like to further segment the super-service group 860, the system 800 can be reconfigured to add an additional receiver 840(2) and fiber link 814(2) as shown in FIG. 10. Thus, super-service group 860 can be more efficiently segmented such that each of the original service groups 860(1)-(4) has a separate output port at the headend/hub 810.

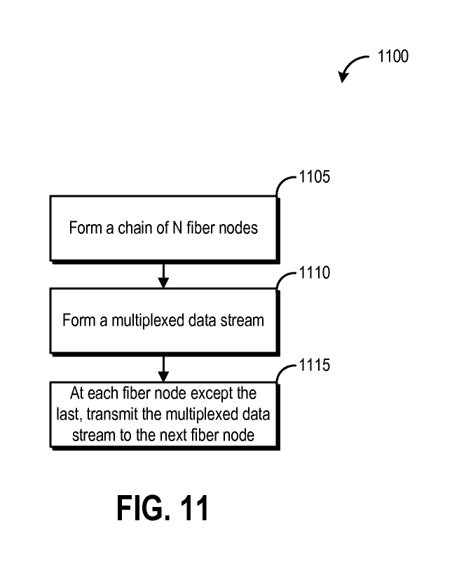

FIG. 11 illustrates an example method 1100 used to aggregate four service groups served by four fiber nodes, respectively, to form a super-service group operable to be more efficiently segmented in the future. Although FIG. 11 is described with reference to four service groups served by four fiber nodes, the description provided within this disclosure is intended to cover segmentation of any number of fiber nodes and service groups.

At stage 1105, a chain of N=4 fiber nodes is formed. As shown in FIG. 6A, for example, for all but the last fiber node in the chain, 630(1), the output of each fiber node is connected to the input of the next fiber node. The output of the last fiber node can be transmitted to a headend/hub as shown in FIGS. 6A and 6B or to another fiber node as shown in FIGS. 8 and 10.

At stage 1110, at each fiber node, a multiplexed data stream is formed. At each fiber node, the multiplexed data stream includes traffic from the service group served by the fiber node and traffic from the service groups served by the fiber nodes preceding the fiber node, if any, in the chain. At each fiber node, the multiplexed data stream can include at least two channels and traffic from each of the service groups included in the multiplexed data stream can be included in a designated one of the at least two channels of the multiplexed data stream.

For example, in the example implementation of FIG. 6A described above, traffic from service groups 660(4) and 660(2) can be designated for channel 1 of the multiplexed stream and traffic from service groups 660(3) and 660(1) can be designated for channel 2. Furthermore, in the example implementation of FIG. 6A, the multiplexed data stream formed at each fiber node includes traffic from the service group served by the fiber node and traffic from the service groups served by the fiber nodes preceding the fiber node.

As discussed above, in fiber node 630(4), a multiplexed signal that includes traffic from service group 630(4) can be generated. More specifically, as discussed above, in fiber node 630(4), a multiplexed signal can be generated where the electrical signals from all the CMs in service group 660(4) can be allocated to a first TDM channel representing CH1. In fiber node 630(3), a multiplexed signal can be generated that includes traffic from service groups 630(3) and 630(4). More specifically, as discussed above, in fiber node 630(3), a multiplexed signal can be generated where the electrical signals from all the CMs in service group 660(4) can be allocated to a first TDM channel representing CH1, and the electrical signals from all the CMs in service group 660(3) can be allocated to a second TDM channel representing CH 2. In fiber node 630(2), a multiplexed signal can be generated that includes traffic from service groups 630(2), 630(3), and 630(4). More specifically, as discussed above, in fiber node 630(2), a multiplexed signal can be generated where the electrical signals from all the CMs in service groups 660(2) and 660(4) can be allocated to a first TDM channel representing CH1, and the electrical signals from all the CMs in service group 660(3) can be allocated to a second TDM channel representing CH2. In fiber node 630(1), a multiplexed signal can be generated that includes traffic from service groups 630(1), 630(2), 630(3), and 630(4). More specifically, as discussed above, in fiber node 630(1), a multiplexed signal can be generated where the electrical signals from all the CMs in service groups 660(2) and 660(4) can be allocated to a first TDM channel representing CH1, and the electrical signals from all the CMs in service groups 660(1) and 660(3) can be allocated to a second TDM channel representing CH2.

At stage 1115, at each fiber node, except the last fiber node in the chain, the multiplexed data stream generated in the fiber node is transmitted to the next fiber node in the chain.

For example, in the implementation of FIG. 6A described above, the multiplexed data stream generated in fiber node 630(4) is transmitted to fiber node 630(3); the multiplexed data stream generated in fiber node 630(3) is transmitted to fiber node 630(2); and the multiplexed data stream generated in fiber node 630(2) is transmitted to fiber node 630(1).

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method of providing service group aggregation where N service groups are served by N fiber nodes, respectively, the method comprising:
forming a chain of N fiber nodes, FN(N), FN(N−1), . . . , FN(1), where for each fiber node, except the last fiber node in the chain, FN(i), i=N, N−1, . . . , 2, the output of the fiber node FN(i) is connected to the input of next fiber node in the chain, FN(i−1);
for each fiber node in the chain, FN(i), i=N, N−1, . . . , 1, forming in the fiber node, FN(i), a multiplexed data stream that includes traffic from the service group served by the fiber node, FN(i), and traffic from the service groups served by the fiber nodes preceding FN(i), if any, in the chain, FN(j), j=i+1, . . . , N, where the multiplexed data stream includes at least two channels and where traffic from each of the service groups included in the multiplexed data stream is included in a designated one of the at least two channels of the multiplexed data stream; and
for each fiber node, except the last fiber node in the chain, FN(i), i=N, N−1, . . . , 2, transmitting the multiplexed data stream formed in the fiber node to the next fiber node in the chain FN(i−1).

2. The method of claim 1, wherein for each fiber node in the chain, FN(i), i=N, N−1, . . . , 1, forming in the fiber node, FN(i), a multiplexed data stream that includes traffic from the service group served by the fiber node, FN(i), and traffic from the service groups served by the fiber nodes preceding FN(i), if any, in the chain, FN(j), j=i+1, . . . , N comprises:
for the first fiber node in the chain, FN(N), multiplexing the traffic from the service group served by FN(N) on a designated one of the at least two channels; and
for each of the remaining fiber nodes in the chain, FN(i), i=N−1, N−2, . . . , 1, demultiplexing the multiplex data stream received from the preceding fiber node, FN(i+1), to form one or more demultiplexed signals where each demultiplexed signal is to be included in one of the at least two channels of the multiplex data stream;
combining the traffic from the service group served by the fiber node FN(i) with the demultiplexed signals to be included on the same channel as the channel for which the traffic from the service group served by FN(i) is to be included; and multiplexing the remaining demultiplexed signals and the signals resulting from the combining step based on the designated channels for the signals.

3. The method of claim 1, wherein the output of last fiber node in the chain, FN(1) is transmitted to another fiber node that is part of another chain of fiber nodes.

4. A system for providing service group aggregation where N service groups are served by N fiber nodes, respectively, the system comprising:
a chain of N fiber nodes, FN(N), FN(N−1), . . . , FN(1), where for each fiber node, except the last fiber node in the chain, FN(i), i=N, N−1, . . . , 2, the output of the fiber node FN(i) is connected to the input of next fiber node in the chain, FN(i−1);
in each fiber node in the chain, FN(i), i=N, N−1, . . . , 1, a multiplexer configured to multiplex on at least two channels traffic from the service group served by the fiber node, FN(i), and traffic from the service groups served by the fiber nodes preceding FN(i), if any, in the chain, FN(j), j=i+1, . . . , N, where traffic from each of the service groups is included in a designated one of the at least two channels; and
in each fiber node in the chain, FN(i), i=N, N−1, . . . , 1, a transmitter configured to transmit the multiplexed data stream formed in the fiber node.

5. A fiber node for providing service group aggregation comprising:
a receiver configured to extracts the digital signals from a received optical signal;
a demultiplexer configured to demultiplex the digital signals extracted from the optical signal by the receiver wherein the each of the demultiplexed signals is designated to be included on a channel of a multiplexed signal and wherein each of the demultiplexed signals are input to a combiner;
a combiner configured to receive one or more input signals including each of the demultiplexed signals from the demultiplexer where each input signal of the combiner is designated to be included on a channel of a multiplexed signal wherein the combiner is configured to combine the input signals designated for the same channel and configured to provide an output signal for each channel of the multiplexed signal wherein each output signal for each channel includes all the input signals for the channel; and
a multiplexer to multiplex the output signals from the combiner.

6. A system for providing service group aggregation where N service groups are served by N fiber nodes, respectively, the system comprising:
a chain of N fiber nodes, FN(N), FN(N−1), . . . , FN(1), where for each fiber node, except the last fiber node in the chain, FN(i), i=N, N−1, . . . , 2, the output of the fiber node FN(i) is connected to the input of next fiber node in the chain, FN(i−1);
means for, for each fiber node in the chain, FN(i), i=N, N−1, . . . , 1, forming in the fiber node, FN(i), a multiplexed data stream that includes traffic from the service group served by the fiber node, FN(i), and traffic from the service groups served by the fiber nodes preceding FN(i), if any, in the chain, FN(j), j=i+1, . . . , N, where the multiplexed data stream includes at least two channels and where traffic from each of the service groups included in the multiplexed data stream is included in a designated one of the at least two channels of the multiplexed data stream; and
means for, for each fiber node, except the last fiber node in the chain, FN(i), i=N, N−1, . . . , 2, transmitting the multiplexed data stream formed in the fiber node to the next fiber node in the chain FN(i−1).
